(19) United States
(12) Patent Application Publication
(10) Pub. No.: US 2008/0171302 A1
(43) Pub. Date: Jul. 17, 2008

(54) Medical Or Dental-Medical Handpiece With Rotary Part And Bearing Arrangement Therefor

(75) Inventor: Bernhard Kuhn, Biberach (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Kaltenbach & Voigt GmbH, Biberach (DE)

(21) Appl. No.: 11/817,954

(22) PCT Filed: Mar. 9, 2006
(86) PCT No.: PCT/EP2006/002186

§ 371 Date: Nov. 1, 2007

(30) Foreign Application Priority Data
Mar. 9, 2005 (DE) 10 2005 010 881.4

(51) Int. Cl. A61C 1/05

(52) U.S. Cl. 433/132

(57) ABSTRACT

In a medical or dental-medical handpiece having a tool, a drive mechanism for the tool has at least one rotary part mounted rotatably by means of a bearing arrangement. The bearing arrangement includes at least one ball bearing with a plurality of balls arranged between an inner track and an outer track, wherein the inner track of the ball bearing is formed by means of the end face of a first bearing part rotatable with the rotary part, and the outer track is formed by means of the end face of a second bearing part fixed in relation to the rotary part.

The present invention relates to a medical or dental-medical handpiece having a tool, in which a drive mechanism for the tool has at least one rotary part mounted rotatably by means of a bearing arrangement and the bearing arrangement includes at least one ball bearing having a plurality of balls arranged between an inner track and an outer track. Furthermore the present invention relates to a bearing arrangement which is provided in particular for use in a medical or dental-medical handpiece, for rotatably mounting a rotary part.

There are medical or dental-medical handpieces in the most different configurations with regard to design and construction, the tool type and tool movement, as well as the drive type. There are known for example handpieces in form of an elongate, straight or angled, grip part. The tool provided for treatment may for example be a rotational tool or a tool movable back and forth. As a drive for this there can be constituted in the handpiece a mechanical drive having a rotatably mounted drive shaft, or a pneumatic drive having a turbine preferably arranged in the forward handpiece region, to which an air-pressure line extends from the rear forwardly.

Medical, in particular dental-medical handpieces can therefore have a rotary part mounted rotatably in any region of their length, which may be constituted for a functional operation from a high speed of rotation to a low speed of rotation. A functional operation at high speed of rotation is used in most cases for a tool for material removing working, e.g. for the removal of caries. There also are, however, handpieces with a tool which is driven with a lower rotational speed. For example in the case of tools which in functional operation carry out screwing work, as is the case in the implantation therapy for the emplacement and removal of dental implants, considerably lower rotational speeds are present but, however, possibly higher torques.

The rotatable mounting of the rotary part is effected with the aid of bearings which make a rotation of the rotary part possible with regard to a base part of the handpiece.

Apart from a classic ball bearing there is also known the use of so-called needle bearings or bearings otherwise configured. Even the use of a so-called air bearing is conceivable in some cases. In most applications, however, so-called ball bearings are put to use which have a plurality of balls which are arranged between an inner ring and an outer ring. Inner ring and outer ring thereby form each a so-called track, wherein the balls can move within the two tracks. Often so-called cages are also put to use which keep the balls at a predetermined distance from each other so that the balls move, upon a rotation of the inner ring with respect to the outer ring, at a constant spacing along the tracks. Both for inner ring and outer ring and also for the balls different materials can be used. These normally consist of steel, however the alternative use of ceramic materials is known in particular for the balls.

In medical or dental-medical handpieces such ball bearings are normally used only in miniaturized form since the confined space conditions within the handpieces make possible only the use of bearings of small size. This means in turn, however, that the loads for the bearings should not be too great, since the narrow inner rings and outer rings, as well as the smaller balls, only bear loads up to a certain degree.

It has turned out now that the loads for such bearings are very great in handpieces which are provided for a surgical use. In particular in such cases in which there are only low rotational speeds but high torques, the loads are even so great that classic ball bearings can no longer be used. Normally with such handpieces there are used sliding bearings, which however lead to high friction losses.

The present invention is based correspondingly on the object of indicating a possibility for mounting rotary parts in the case of medical or dental-medical handpieces in a simple and effective way. In particular there is to be provided a bearing arrangement which manifests slight friction losses but is tolerant of loads as well as is possible.

The object is achieved by means of a medical or dental-medical handpiece having the features of the claim 1. The object is further achieved by means of a bearing arrangement for use in the case of a medical or dental-medical handpiece, in accordance with claim 14. Advantageous further developments of the invention are subject of the dependent claims.

The solution in accordance with the invention is based on the idea, for the formation of the inner track and on the outer track of the ball bearing, of not—as to date—using two ring parts, the inside and outside surfaces of which respectively form the tracks. Instead, in accordance with the invention, there are used two bearing parts axially offset from one another, the end faces of which towards one another are so configured that they form the tracks for the balls.

In accordance with a first aspect of the present invention a medical or dental-medical handpiece having a tool is therefore proposed wherein a drive mechanism for the tool has at least one rotary part mounted rotatably by means of a bearing arrangement, and wherein the bearing arrangement includes at least one ball bearing with a plurality of balls arranged between an inner track and an outer track. In accordance with the invention the inner track of the ball bearing is formed by the end face of a first bearing part rotatable with the rotary part, and the outer track is formed by the end face of a second bearing part fixed with respect to the rotary part.

The solution in accordance with the invention allows the configuration of the tracks for the bearing in a simple manner, by material removing working of the end faces of the bearing parts, in particular by turning. This is not only of advantage with regard to the costs arising in the production of the parts; beyond this it has shown itself that excellent running qualities are attained and the bearings in particular have a high capacity to handle loads even with the smallest structural form. The running qualities of the bearings are thereby so advantageous that the use of a separate cage for the defined arrangement of the balls within the tracks can even be forgone. There is therefore obtained a particularly simple structural form for the bearing which has clear advantages with respect to classic ball bearings with regard to the production costs as well as the operational qualities.

In an advantageous development of the present invention it is provided that one of the two bearing parts is biased in axial direction with respect to the other bearing part. This biasing can be effected for example by means of a spring element which is arranged between the bearing part to be biased and a shoulder area or end face of an intermediate piece engaging around the rotary part. This spring element can in particular be formed by a flat spring.

The bearing part forming the inner track can for example be formed by a bearing bushing arranged on the rotary part, which is fixedly arranged on the rotary part and turns therewith. In turn the second bearing part can be formed by an outer ring fixed with respect the rotary part.

The end faces of the two bearing parts which form the inner track and the outer track of the bearing arrangement in accordance with the invention are preferably configured as quarter circles so that two tracks turned towards each other are formed for the balls.

At its two ends, the rotary part may in each case be mounted via a ball bearing which is configured according to the present invention. Beyond this an additional mounting could, however, still be effected via a so-called needle bearing. In this case the rolling bodies of the needle bearing are arranged between the outer wall of the rotary part and the inside wall of a ring-like recess of the intermediate piece.

In accordance with the invention there is also proposed a bearing arrangement for mounting at least one rotary part within a medical or dental-medical handpiece, wherein the bearing arrangement includes a ball bearing having a plurality of balls arranged between an inner track and an outer track, and wherein in accordance with the invention the inner track of the ball bearing is formed by the end face of a first bearing part rotatable with the rotary part, and the outer track is formed by the end face of a second bearing part fixed with respect to the rotary part.

Below, the invention will be explained in more detail with reference to the accompanying drawings. There is shown:

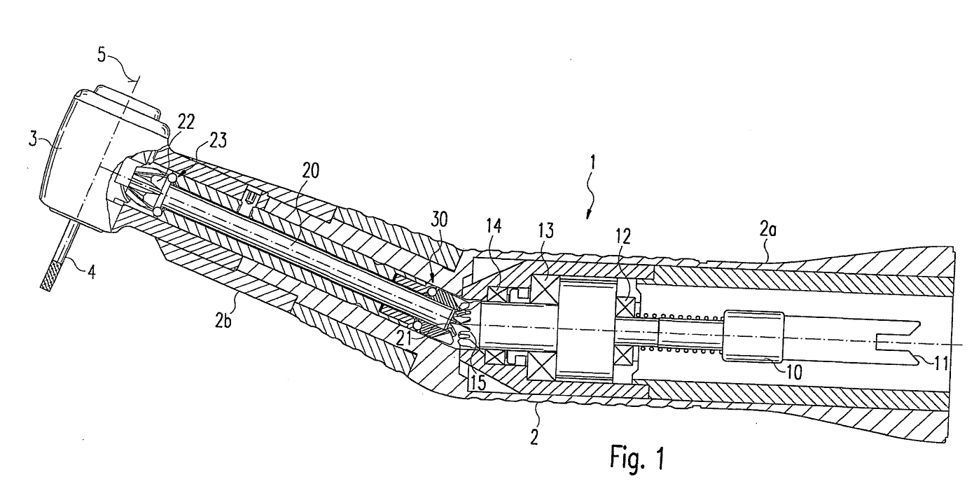

FIG. 1 a dental-medical handpiece, in lateral section, in which a bearing arrangement in accordance with the invention is put to use;

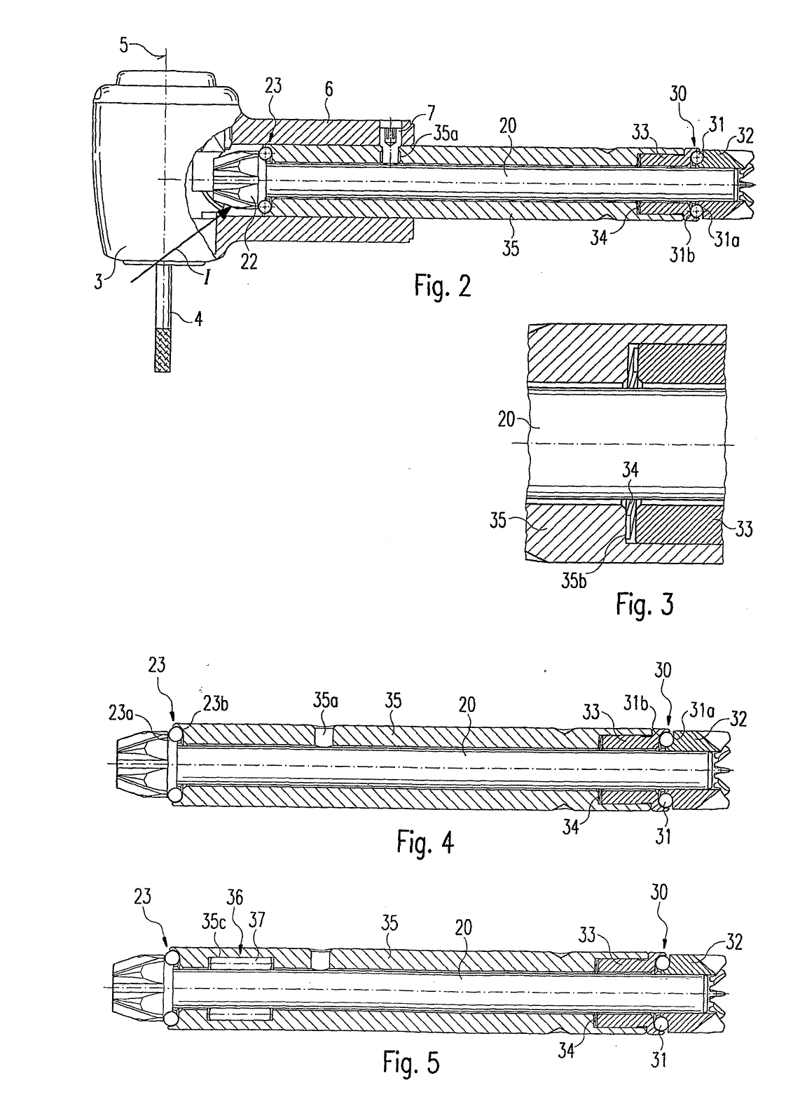

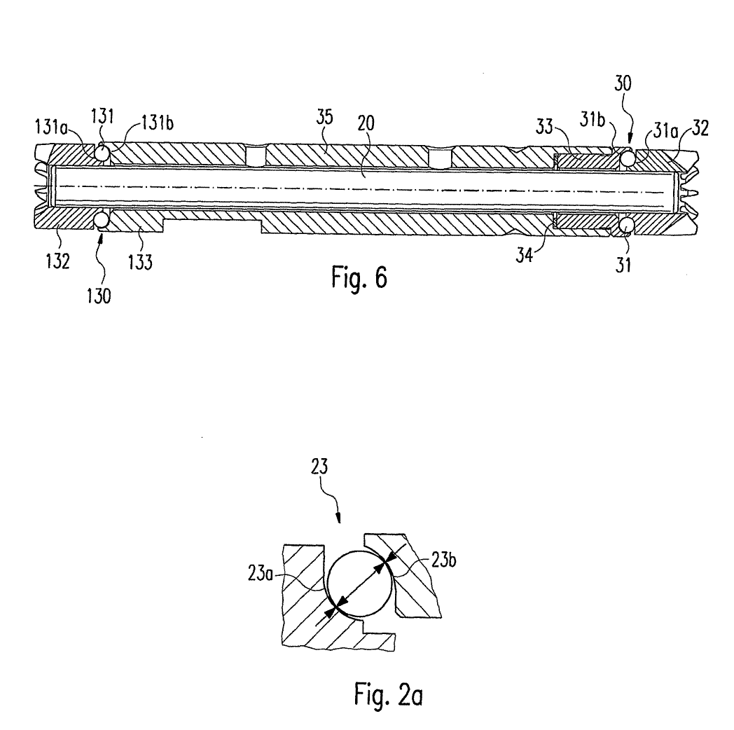

FIG. 2 an illustration to an enlarged scale of the head region of the handpiece of FIG. 1;

FIG. 2a a detail illustration of the forward bearing in FIG. 2;

FIG. 3 a detail of the bearing arrangement in accordance with the invention;

FIG. 4 the rotatable mounting of a shaft with the aid of a bearing arrangement in accordance with the invention;

FIG. 5 a variant of the arrangement of FIG. 4 and

FIG. 6 a further variant on the mounting of a shaft in accordance with the invention.

FIG. 1 shows a dental handpiece, generally designated by reference sign 1, which has an angled grip sleeve 2 with a coupling piece 2a and an intermediate piece 2b, at the forward end of which a handpiece head 3 is arranged. Within the handpiece head 3 a dental treatment tool 4 is mounted rotatably around an axis 5. In the illustrated embodiment there is involved in particular a dental surgery handpiece with which the tool 4 is operated with low rotational speeds but at relatively high torques.

The drive of the tool 4 is effected with the aid of a motor which is arranged within a not illustrated motor piece with which the handpiece 1 illustrated in FIG. 1 can be coupled. For this purpose, by means of coupling elements, not illustrated in detail, the handpiece 1 is placed on the motor piece, wherein there is then coupled with the motor an engaging piece 11 of a drive mechanism of the handpiece 1 and correspondingly the tool 4 is put into rotation via the drive mechanism. The individual components of the drive mechanism will be explained below.

Firstly, the drive mechanism consists of a first shaft 10 which is arranged in the coupling piece 2a of the sleeve 2 and at its rearward end has the engaging piece 11 for coupling with the motor. The mounting of this shaft 10 is effected within the coupling piece 2a by means of a plurality of bearings 12, 13 and 14, which may for example be ball bearings. In this coupling piece 2a the use of ball bearings is still possible since here the space conditions allow use of bearings of larger structure.

A second shaft 20 is arranged within the intermediate piece 2b, which is angled with respect to the coupling piece 2a. It is the task of this second shaft 20 to transfer the rotation of the first shaft 10 to the head piece 3, in order there to cause a rotation of the tool 4. For this purpose the second shaft 20 has at its rearward end first coupling parts 21 which cooperate with coupling parts 15 of the shaft 10. At its forward end the second shaft of 20 further has coupling parts 22 which cooperate with coupling parts within the head piece 3 which are not illustrated in detail.

The mounting of the second shaft 20 is effected by means of two bearings 23 and 30 whose detailed configuration can be discerned from FIG. 2. It is to be taken into account that the space conditions within the intermediate piece 2b only allow the use of bearings of lesser size. Since, however, larger loads arise in particular in the rearward region of the shaft, in accordance with the invention a particular bearing arrangement 30 is used in this region for the mounting of the shaft 20, as will be explained below with reference to FIGS. 2 and 3.

The bearing arrangement 30 in accordance with the invention is in turn configured as a ball bearing and has a plurality of, preferably 14, balls 31, which are guided between two tracks provided with the reference signs 31a and 31b and make possible a rotation of the shaft 20 relative to a fixed so-called intermediate piece 35 which extends within the grip sleeve 2. The intermediate piece 35 is coupled with the head part 3 of the handpiece, for which purpose the head part has a sleeve 6 projecting to the rear which engages over the intermediate piece 35. In the rearward end region the sleeve 6 has a latch pin 7 which engages into a recess 35a of the intermediate piece and through this brings about a latching and axial fastening of the two parts.

For the formation of a classic ball bearing the inner track and outer track for the balls are normally formed by two bearing rings which have ring-like depressions or recesses in their outside or in their inside surface, which form the tracks. Also with the bearing arrangement in accordance with the invention the tracks 31a and 31b are formed by correspondingly configured bearing parts 32 and 33, wherein the running surfaces are now, however, not formed on the outside surface or on the inside surface of the two bearing parts, but instead are formed at the end faces thereof.

As can be discerned from the illustration in FIG. 2 the two end faces are each configured, seen in cross-section, in quarter circle shape, through which there are formed running surfaces, facing one another, which on the one hand bear on external surfaces towards the shaft 20, and on the other hand bear on the external surfaces of the balls 31. The end face of the first bearing part 32, which is fixedly arranged on the shaft 20 and turns therewith, correspondingly forms an inner track 31 a for the balls 31, whilst in contrast the end face of the second bearing part 33 forms an outer track 31 b for the balls 31. The second bearing part 33 is also formed by a sleeve-like part, which however does not turn with the shaft 20, but instead is arranged fixedly with regard to this.

The end faces of the two bearing parts 32 and 33 therefore form tracks which together almost completely engage around the balls 31. Through this a very stable arrangement for the bearing is obtained, which even allows the cage normally used for the defined arrangement of the balls 31 within the tracks to be forgone. The configuration of the end faces of the two bearing parts 32 and 33 can for example be effected by appropriate turning, which also brings about advantages with regard to the cost outlay in the production of the bearing.

Good running qualities for the—cage-less—bearing arrangement 30 in accordance with the invention, are obtained in particular then if it is ensured that the balls 31 are fixedly arranged within their tracks 31a and 31b. It is correspondingly provided that one of the two bearing parts 32, 33 is biased in axial direction with respect to the other one. In the illustrated embodiment this is effected in that on the rearward end face of the second bearing part 33 there is arranged a flat spring 34, which—as can be discerned in particular from the illustration to an enlarged scale of FIG. 3—pushes against an end face or a shoulder 35b of the intermediate piece 35. In this way the second bearing part 33 is biased in the direction of the first bearing part 32, so that a secure mounting of the balls 31 is obtained within their tracks 31a and 31b. The mounting of the shaft 20 overall provided thereby can be discerned again from the illustration in FIG. 4.

Otherwise, the bearing 23 towards the handpiece head 3 is also configured in inventive manner. Thus, also with this bearing 23 the end faces, towards one another, of the coupling part 22 connected with the shaft 20 and of the intermediate piece 35, form tracks 23a, 23b for the balls. In connection with this, it also has to be pointed out that the configuration of the bearing in accordance with the invention brings about particular advantages with regard to take up of force. Namely, as is schematically represented by the arrow I in FIG. 2, in the operation of the handpiece there arises a main load direction, which from direction of the drill 4 runs obliquely upwardly towards the bearing 23. Corresponding to the illustration to an enlarged scale of FIG. 2a, the configuration of the tracks is now such that the balls are enclosed exactly in the force direction. Thus there is provided an ideal force take-up by the bearing, which leads to a further improvement of the running qualities.

Particular advantages of the bearing arrangement 30 in accordance with the invention consist further in that on the one hand few components are used and on the other hand the bearing parts 32 and 33 forming the tracks 31a and 31b can be configured with a certain size or breadth. Through this there is the possibility of configuring the bearing parts at least such that they withstand also larger loads, which e.g. could appear with operation at high torques. The bearing arrangement in accordance with the invention can thus take up considerably greater forces in comparison with conventional ball bearings with miniaturized inner and outer rings. Despite everything, the running qualities of the arrangement in accordance with the invention are at least comparable with classic ball bearings, so that also use at speeds in the region would of up to 40,000 revolutions per minute would be conceivable. Decisive for the good qualities of the arrangement in accordance with the invention is in particular also the integrated situation of the two bearing parts to one another, which is effected through the biasing with the aid of the flat spring. All parts of the bearing arrangement should of course consist of a hardened material, for example steel, whereby however for example also the use of ceramic balls also would be conceivable.

FIG. 5 shows a variant for the mounting of the shaft 20 in accordance with the illustration in FIG. 4. With the variant in accordance with FIG. 5 there is additionally provided a needle bearing 36 in the forward end region of the shaft 20, which is used for the additional mounting of the shaft 20. In this case the roller bodies 37 of the needle bearing 36 are arranged between the outer wall of the shaft 20 and the inside wall of a ring-like recess 35c of the intermediate piece 35. Also here the rearward bearing 30 is formed by the arrangement in accordance with the invention, with which the tracks are formed by means of the end faces of the bearing parts 32 and 33.

FIG. 6 finally shows a further embodiment for the mounting of a shaft 20, in which the same elements are provided with the same reference signs. The development of the embodiment in accordance with FIG. 6 consists in that also in the case of the bearing 130 in the forward end region of the shaft 20 there is provided an additional bearing part for forming the inner track. Thus, in turn two bearing parts 132 and 133 are provided for the mounting of the balls 131, the end faces of which form the inner and outer tracks 131a and 131b for the balls 131. Bearing part 132 forming the inner track 131a represents in this case at the same time also the coupling piece for the coupling with the drive mechanism within the head part 3 of the dental handpiece 1, while in contrast the second bearing part 133 is formed by the intermediate piece 35. In turn the two end faces of the two bearing parts 132 and 133 are configured quarter circle shaped so that they form the tracks for the balls 131.

Overall, there is thus provided in accordance with the present invention a new type bearing arrangement for the rotatable mounting of a rotary part in particular within a medical or dental-medical handpiece, which despite slight structural size can be exposed to high loads. Despite everything, excellent running qualities are obtained so that the bearing in accordance with the invention is versatile in application and has a high operational reliability. Furthermore the configuration of the bearing arrangement in accordance with the invention also allows the same an economical production.

1. Medical or dental-medical handpiece having a tool, said handpiece comprising a drive mechanism for the tool having at least one rotary part rotatably mounted by a bearing arrangement,
wherein the bearing arrangement includes at least one ball bearing with a plurality of balls arranged between an inner track and an outer track (31b, 131b)),
wherein
the inner track of the ball bearing is formed by an end face of a first bearing part rotatable with the rotary part, and the outer track is formed by an end face of a second bearing part fixed with respect to the rotary part.

2. Medical or dental-medical handpiece according to claim 1,
wherein
one of the first and second bearing parts is axially biased in the direction of the other bearing part.

3. Medical or dental-medical handpiece according to claim 2,
wherein
the biasing is effected by a spring element arranged between a corresponding bearing part and a shoulder or end face of an intermediate piece engaging around the rotary part.

4. Medical or dental-medical handpiece according to claim 3,
wherein
the spring element is a flat spring.

5. Medical or dental-medical handpiece according to
wherein
the first bearing part is formed by a bearing bushing arranged on the rotary part.

6. Medical or dental-medical handpiece according to
claim 1, wherein
the second bearing part is formed by an outer ring fixed with respect to the rotary part.

7. Medical or dental-medical handpiece according to
claim 1, wherein
the end faces of the first and second bearing parts forming the inner track and the outer track are of approximately quarter circle shape.

8. Medical or dental-medical handpiece according to
claim 1, wherein
the rotary part is mounted at two ends thereof via ball bearings.

9. Medical or dental-medical handpiece according to
claim 1, wherein
the mounting of the rotary part is effected via a needle bearing.

10. Medical or dental-medical handpiece according to claim 9,
wherein roller bodies associated with the needle bearing are arranged between an outer wall of the rotary part and an inside wall of a ring-like recess of the intermediate piece.

11. Medical or dental-medical handpiece according to
claim 1, wherein
the two bearing parts are of a hardened material.

12. Medical or dental-medical handpiece according to
claim 1, wherein
the balls are of hardened steel or of a ceramic material.

13. Medical or dental-medical handpiece according to
claim 1, comprising a dental surgery handpiece.

14. Bearing arrangement for the mounting of a rotary part within a medical or dental-medical handpiece
comprising a ball bearing with a plurality of balls (31, 131) arranged between an inner track and an outer track,
wherein
the inner track of the ball bearing is formed by an end face of a first bearing part rotatable with the rotary part, and the outer track is formed by an end face of a second bearing part fixed with respect to the rotary part.

15. Bearing arrangement according to claim 14,
wherein
one of the first and second bearing parts is axially biased in the direction of the other bearing part.

16. Bearing arrangement according to claim 15,
wherein
the biasing is effected by means of a spring element which is arranged between a corresponding bearing part and a shoulder or end face of an intermediate piece engaging around the rotary part.

17. Bearing arrangement according to claim 16,
wherein
the spring element is a flat spring.

18. Bearing arrangement according to,
claim 14, wherein
the first bearing part is formed by a bearing bushing arranged on the rotary part.

19. Bearing arrangement according to,
claim 14, wherein
the second bearing part is formed by an outer ring fixed with regard to the rotary part.

20. Bearing arrangement according to,
claim 14, wherein
end faces of the first and second bearing parts forming the inner track and the outer track (31b, 131b) are of approximately quarter circle shape.

21. Bearing arrangement according to,
claim 14, wherein
the first and second bearing parts are of a hardened material.

22. Bearing arrangement according to,
claim 14, wherein
the balls are of hardened steel or of a ceramic material.

23. Medical or dental handpiece according to claim 11, wherein the two bearing parts are of hardened steel.

24. Bearing arrangement according to claim 21, wherein the two bearing parts are of hardened steel.
